(19) United States
(12) Patent Application Publication
(10) Pub. No.: US 2008/0222878 A1
(43) Pub. Date: Sep. 18, 2008

(54) Method of manufacturing magnetic head

(75) Inventors: Takeo Kagami, Tokyo (JP); Tetsuro Sasaki, Tokyo (JP); Yuichi Watabe, Tokyo (JP); Takamitsu Sakamoto, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/723,127

(22) Filed: Mar. 16, 2007

(51) Int. Cl. G11B 5/127

(52) U.S. Cl. 29/603.12; 360/313; 29/603.13

(57) ABSTRACT

A method of manufacturing a magnetic head includes the steps of: fabricating a substructure in which pre-head portions are aligned in a plurality of rows by forming components of a plurality of magnetic heads on a single substrate; and fabricating the plurality of magnetic heads by separating the pre-head portions from one another through cutting the substructure. In the step of fabricating the substructure, the resistance of an MR film that will be formed into an MR element by undergoing lapping later is detected to determine the target position of the boundary between a track width defining portion and a wide portion of a pole layer based on the resistance thus obtained, and the pole layer is thereby formed. In the step of fabricating the magnetic heads, the surface formed by cutting the substructure is lapped such that the MR film is lapped and the resistance thereof thereby reaches a predetermined value.

### BACKGROUND OF THE INVENTION

1. Field of the Invention

The present invention relates to a method of manufacturing a magnetic head used for writing data on a recording medium and reading data stored on the recording medium.

2. Description of the Related Art

For magnetic read/write devices such as magnetic disk drives, higher recording density has been constantly required to achieve a higher storage capacity and smaller dimensions. Typically, magnetic heads used in magnetic read/write devices are those having a structure in which a reproducing (read) head having a magnetoresistive element (that may be hereinafter called an MR element) for reading and a recording (write) head having an induction-type electromagnetic transducer for writing are stacked on a substrate.

For read heads, GMR (giant magnetoresistive) elements utilizing a giant magnetoresistive effect have been practically used as MR elements. Conventional GMR elements have a current-in-plane (CIP) structure in which a current used for detecting magnetic signals (that is hereinafter called a sense current) is fed in the direction parallel to the plane of each layer making up the GMR element. Recently, there has been proposed another type of GMR element having a current-perpendicular-to-plane (CPP) structure in which the sense current is fed in a direction-intersecting the plane of each layer making up the GMR element, such as the direction perpendicular to the plane of each layer making up the GMR element. TMR elements utilizing a tunneling magnetoresistive effect are also known as another type of MR element. The TMR elements have a CPP structure, too. To achieve higher recording density of magnetic read/write devices, MR elements have been recently shifted from conventional GMR elements having the CIP structure to TMR elements or GMR elements having the CPP structure.

Write heads include those of a longitudinal magnetic recording system wherein signals are magnetized in the direction along the surface of the recording medium (the longitudinal direction) and those of a perpendicular magnetic recording system wherein signals are magnetized in the direction perpendicular to the surface of the recording medium. Recently, the shift from the longitudinal magnetic recording system to the perpendicular magnetic recording system has been promoted in order to achieve higher recording density of magnetic read/write devices.

In each of the longitudinal and perpendicular magnetic recording systems, the write head typically incorporates a coil for generating a magnetic field corresponding to data to be written on a recording medium, and a pole layer for allowing a magnetic flux corresponding to the magnetic field generated by the coil to pass therethrough and generating a write magnetic field for writing the data on the recording medium. The pole layer includes a track width defining portion and a wide portion, for example. The track width defining portion has a first end located in a medium facing surface and a second end located away from the medium facing surface, and has a width that defines the track width. The wide portion is coupled to the second end of the track width defining portion and has a width greater than the width of the track width defining portion. Here, the length of the track width defining portion taken in the direction orthogonal to the medium facing surface is called a neck height. The neck height exerts influences on write characteristics such as an overwrite property.

An example of a method of manufacturing a magnetic head will now be described. In the method, first, components of a plurality of magnetic heads are formed on a single substrate (wafer) to fabricate a magnetic head substructure in which pre-head portions each of which will be the magnetic head later are aligned in a plurality of rows. The substructure includes a plurality of magnetoresistive films (hereinafter referred to as MR films) each of which will be formed into an MR element by undergoing lapping later. Each of the MR films has such a shape that the length taken in the direction orthogonal to the medium facing surface is greater than the length of the MR element and that the width is equal to the width of the MR element. Next, the substructure is cut to fabricate a head aggregate that includes a plurality of pre-head portions aligned in a row. Next, a surface formed in the head aggregate by cutting the substructure is lapped to form the medium facing surface of each of the pre-head portions that the head aggregate includes. At this time, each of the MR films is lapped, so that the length thereof reaches a predetermined length and the resistance thereof reaches a predetermined value, and as a result, the MR films are formed into the MR elements. Next, flying rails are formed in the medium facing surface. Next, the head aggregate is cut so that the plurality of pre-head portions are separated from one another, and a plurality of magnetic heads are thereby formed.

An example of a method of forming the medium facing surface by lapping the head aggregate will now be described. In the method, there are formed in advance in the substructure a plurality of resistor layers whose resistances will change with changing amount of lapping when the head aggregate is lapped later. The resistance of each of the resistor layers has a correspondence with the resistance of the MR element. When the head aggregate is lapped, lapping is performed while detecting the resistances of the plurality of resistor layers so that the resistance of each of the plurality of resistor layers is of a predetermined value. As a result, the medium facing surfaces are formed such that the resistance of each of the plurality of MR elements is equal to the target value thereof and that each of the MR heights is equal to the target value thereof. The MR height is the length of the MR element taken in the direction orthogonal to the medium facing surface. Such a method of forming the medium facing surface as described so far is disclosed in JP 11-134614A or JP 2005-317069A, for example.

In the conventional method of manufacturing a magnetic head, the substructure is fabricated such that there is a specific positional relationship between the MR film and the pole layer. Therefore, ideally, if the medium facing surfaces are formed such that each of the MR heights is of a specific value, uniform MR heights are thereby obtained.

If there is no variation in resistance-area product (RA) and width of the MR film among a plurality of substructures, it is possible to form MR elements through the above-described method of forming medium facing surfaces, such that the resistance of each of the MR elements is equal to the target value thereof and that each of the MR heights is equal to the target value thereof. In practice, however, there are some cases in which variations occur in resistance-area product and width of the MR film among a plurality of substructures. Even in such cases, it is possible to make the resistances of the MR elements uniform by lapping such that the resistance of each of the MR elements is equal to the target value. However, in the cases in which variations occur in resistance-area product and width of the MR film, if the MR elements are formed such that the resistances of the MR elements are uniform, there occur variations in MR height. In the case in which the MR film and the pole layer are formed to have a specific positional relationship with each other as previously described, if there occur variations in MR height, there occur variations in neck height, too.

Conventionally, in the case of write heads of the longitudinal magnetic recording system, when the recording density is low, variations in neck height do not exert great influences on write characteristics such as an overwrite property. However, as the recording density is increased, variations in neck height exert greater influences on write characteristics. In the case of write heads of the perpendicular magnetic recording system, variations in neck height exert greater influences on write characteristics, compared with write heads of the longitudinal magnetic recording system. Because of the foregoing, it has been required recently to reduce variations in neck height so as to obtain desired write characteristics. However, no method has been proposed for reducing variations in both the resistance of the MR element and the neck height.

### OBJECT AND SUMMARY OF THE INVENTION

It is an object of the invention to provide a method of manufacturing a magnetic head capable of reducing variations in both the resistance of a magnetoresistive element and the neck height of a pole layer.

A magnetic head manufactured through a first or a second manufacturing method of the invention includes: a medium facing surface that faces toward a recording medium; a magnetoresistive element having an end located in the medium facing surface and reading data stored on the recording medium; a coil that generates a magnetic field corresponding to data to be written on the recording medium; and a pole layer that allows a magnetic flux corresponding to the magnetic field generated by the coil to pass therethrough and generates a write magnetic field for writing the data on the recording medium. The pole layer includes: a track width defining portion including a first end located in the medium facing surface and a second end located away from the medium facing surface, and having a width that defines a track width; and a wide portion coupled to the second end of the track width defining portion and having a width greater than that of the track width defining portion. The magnetic head may be one used for a perpendicular magnetic recording system.

The first manufacturing method for a magnetic head of the invention includes the steps of: fabricating a magnetic head substructure in which a plurality of pre-head portions each of which will be the magnetic head later are aligned in a plurality of rows, by forming components of a plurality of magnetic heads on a substrate; and fabricating the plurality of magnetic heads by separating the pre-head portions from one another through cutting the substructure. The step of fabricating the substructure includes the steps of: forming a magnetoresistive film that will be formed into the magnetoresistive element by undergoing lapping later; detecting a resistance of the magnetoresistive film; determining a target position of a boundary between the track width defining portion and the wide portion of the pole layer based on the resistance of the magnetoresistive film detected; and forming the pole layer such that an actual position of the boundary between the track width defining portion and the wide portion coincides with the target position. The step of fabricating the magnetic heads includes the step of forming the medium facing surface by lapping a surface formed by cutting the substructure. In the step of forming the medium facing surface, the lapping is performed such that the magnetoresistive film is lapped and the resistance thereof thereby reaches a predetermined value, and as a result, the magnetoresistive film is formed into the magnetoresistive element.

In the first manufacturing method of the invention, in the step of detecting the resistance of the magnetoresistive film, the resistance of the magnetoresistive film may be detected while a magnetic field is applied to the magnetoresistive film.

In the first manufacturing method of the invention, the magnetoresistive film may include: a pinned layer having a fixed direction of magnetization; a free layer having a direction of magnetization that changes in response to an external magnetic field; and a spacer layer disposed between the pinned layer and the free layer. In this case, in the step of detecting the resistance of the magnetoresistive film, the resistance of the magnetoresistive film may be detected with the direction of magnetization of the free layer rendered parallel to the direction of magnetization of the pinned layer by applying a magnetic field to the magnetoresistive film.

The second manufacturing method for a magnetic head of the invention includes the steps of: fabricating a magnetic head substructure in which a plurality of pre-head portions each of which will be the magnetic head later are aligned in a plurality of rows, by forming components of a plurality of magnetic heads on a substrate; and fabricating the plurality of magnetic heads by separating the pre-head portions from one another through cutting the substructure. The step of fabricating the substructure includes the steps of: forming a magnetoresistive film that will be formed into the magnetoresistive element by undergoing lapping later; detecting a value of a parameter having a correspondence with a resistance of the magnetoresistive film; determining a target position of a boundary between the track width defining portion and the wide portion of the pole layer based on the value of the parameter detected; and forming the pole layer such that an actual position of the boundary between the track width defining portion and the wide portion coincides with the target position. The step of fabricating the magnetic heads includes the step of forming the medium facing surface by lapping a surface formed by cutting the substructure. In the step of forming the medium facing surface, the lapping is performed such that the magnetoresistive film is lapped and the resistance thereof thereby reaches a predetermined value, and as a result, the magnetoresistive film is formed into the magnetoresistive element.

In the second manufacturing method of the invention, the step of fabricating the substructure may further include the step of forming a detection element having a resistance-area product equal to that of the magnetoresistive film, and, in the step of detecting the value of the parameter, a value of the resistance-area product of the detection element may be detected as the value of the parameter. In this case, the value of the resistance-area product of the detection element may be detected while a magnetic field is applied to the detection element.

Each of the magnetoresistive film and the detection element may include: a pinned layer having a fixed direction of magnetization; a free layer having a direction of magnetization that changes in response to an external magnetic field; and a spacer layer disposed between the pinned layer and the free layer. In this case, in the step of detecting the value of the resistance-area product of the detection element, the value of the resistance-area product of the detection element may be detected with the direction of magnetization of the free layer rendered parallel to the direction of magnetization of the pinned layer by applying a magnetic field to the detection element.

According to the first manufacturing method for a magnetic head of the invention, in the step of fabricating the substructure, the resistance of the magnetoresistive film is detected, the target position of the boundary between the track width defining portion and the wide portion of the pole layer is determined based on the resistance of the magnetoresistive film detected, and the pole layer is formed such that an actual position of the boundary between the track width defining portion and the wide portion coincides with the target position. In the step of fabricating the magnetic heads, the lapping is performed on the surface formed by cutting the substructure, such that the magnetoresistive film is lapped and the resistance thereof thereby reaches a predetermined value, and as a result, the magnetoresistive film is formed into the magnetoresistive element. As a result, according to the invention, it is possible to reduce variations in both resistance of the magnetoresistive element and neck height of the pole layer.

In the first manufacturing method of the invention, the resistance of the magnetoresistive film may be detected while a magnetic field is applied to the magnetoresistive film. In this case, the accuracy in detection of the resistance of the magnetoresistive film is enhanced, and the accuracy in the target position of the boundary between the track width defining portion and the wide portion is thereby enhanced, too.

In the first manufacturing method of the invention, in the case in which the magnetoresistive film includes the pinned layer, the free layer and the spacer layer, the resistance of the magnetoresistive film may be detected with the direction of magnetization of the free layer rendered parallel to the direction of magnetization of the pinned layer by applying a magnetic field to the magnetoresistive film. In this case, the accuracy in detection of the resistance of the magnetoresistive film is enhanced, and the accuracy in the target position of the boundary between the track width defining portion and the wide portion is thereby enhanced, too.

According to the second manufacturing method for a magnetic head of the invention, in the step of fabricating the substructure, the value of the parameter having a correspondence with the resistance of the magnetoresistive film is detected, the target position of the boundary between the track width defining portion and the wide portion of the pole layer is determined based on the value of the parameter detected, and the pole layer is formed such that an actual position of the boundary between the track width defining portion and the wide portion coincides with the target position. In the step of fabricating the magnetic heads, the lapping is performed on the surface formed by cutting the substructure, such that the magnetoresistive film is lapped and the resistance thereof thereby reaches a predetermined value, and as a result, the magnetoresistive film is formed into the magnetoresistive element. As a result, according to the invention, it is possible to reduce variations in both resistance of the magnetoresistive element and neck height of the pole layer.

In the second manufacturing method of the invention, the step of fabricating the substructure may further include the step of forming a detection element having a resistance-area product equal to that of the magnetoresistive film, and, in the step of detecting the value of the parameter, a value of the resistance-area product of the detection element may be detected as the value of the parameter. In this case, the value of the resistance-area product of the detection element may be detected while a magnetic field is applied to the detection element. In this case, the accuracy in detection of the resistance-area product of the detection element is enhanced, and the accuracy in the target position of the boundary between the track width defining portion and the wide portion is thereby enhanced, too. In the case in which each of the magnetoresistive film and the detection element includes the pinned layer, the free layer and the spacer layer, the resistance-area product of the detection element may be detected with the direction of magnetization of the free layer rendered parallel to the direction of magnetization of the pinned layer by applying a magnetic field to the detection element. In this case, too, the accuracy in detection of the resistance-area product of the detection element is enhanced, and the accuracy in the target position of the boundary between the track width defining portion and the wide portion is thereby enhanced, too.

Other and further objects, features and advantages of the invention will appear more fully from the following description.

### BRIEF DESCRIPTION OF THE DRAWINGS

FIG. 1 illustrates a portion of a pole layer of a magnetic head of a first embodiment of the invention in a neighborhood of a medium facing surface.

FIG. 2 is a cross-sectional view for illustrating the configuration of the magnetic head of the first embodiment of the invention.

FIG. 3 is a front view of the medium facing surface of the magnetic head of the first embodiment of the invention.

FIG. 4 is a cross-sectional view for illustrating an example of the configuration of an MR element of the first embodiment of the invention.

FIG. 5 is a top view of a magnetic head substructure of the first embodiment of the invention.

FIG. 6 is a view for illustrating part of the magnetic head substructure of the first embodiment of the invention.

FIG. 7 is a flow chart for showing the outline of a method of manufacturing the magnetic head of the first embodiment of the invention.

FIG. 8 is a cross-sectional view of a layered structure obtained in the course of a process of fabricating the substructure of the first embodiment of the invention.

FIG. 9 is a top view of am MR film of the first embodiment of the invention.

FIG. 10 is a cross-sectional view of a layered structure obtained in the course of the process of fabricating the substructure of the first embodiment of the invention.

FIG. 11 is a top view of a layered structure obtained in the course of the process of fabricating the substructure of the first embodiment of the invention.

FIG. 12 is a top view of a layered structure obtained in the course of the process of fabricating the substructure of the first embodiment of the invention.

FIG. 13 is a cross-sectional view of the substructure of the first embodiment of the invention.

FIG. 14 is a perspective view for illustrating an example of the configuration of a lapping apparatus for lapping a head aggregate of the first embodiment of the invention.

FIG. 15 is a block diagram illustrating an example of circuit configuration of the lapping apparatus of FIG. 14.

FIG. 16 is a perspective view for illustrating an example of appearance of the magnetic head of the first embodiment of the invention.

FIG. 17 is a perspective view of a head arm assembly of the first embodiment of the invention.

FIG. 18 is a view for illustrating a main part of a magnetic disk drive of the first embodiment of the invention.

FIG. 19 is a top view of the magnetic disk drive of the first embodiment of the invention.

FIG. 20 is a view for illustrating part of a substructure of a second embodiment of the invention.

FIG. 21 is a flow chart for showing the outline of a method of manufacturing a magnetic head of the second embodiment of the invention.

### DETAILED DESCRIPTION OF THE PREFERRED EMBODIMENTS

### First Embodiment

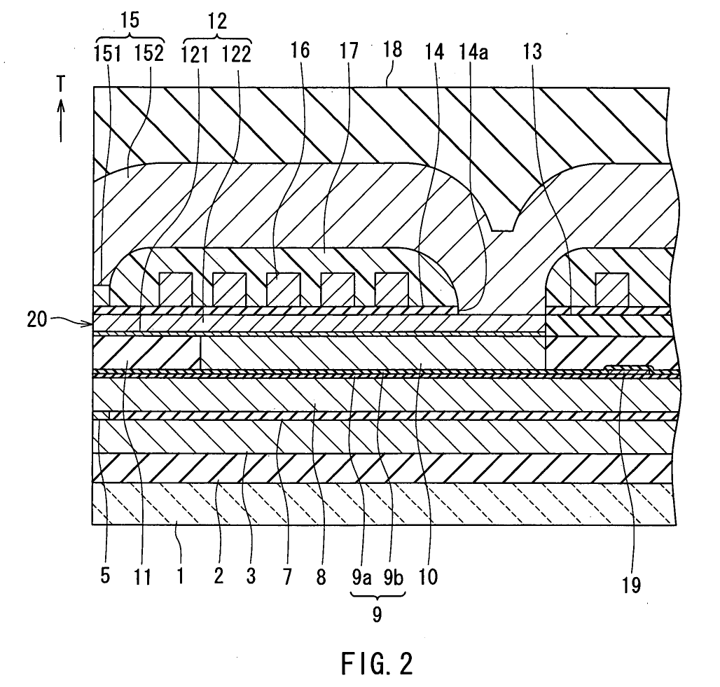

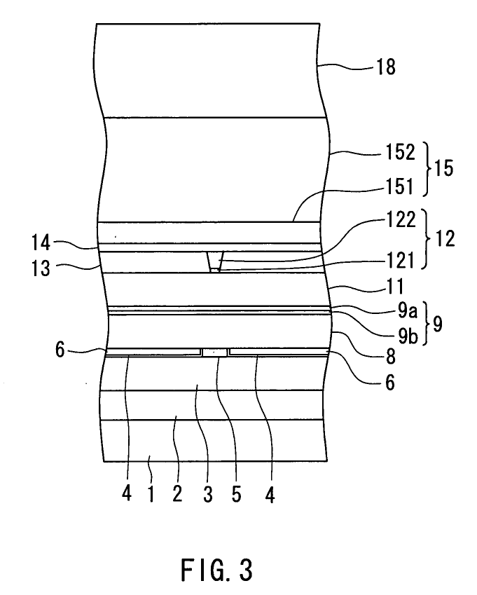

Preferred embodiments of the invention will now be described in detail with reference to the accompanying drawings. Reference is now made to FIG. 2 and FIG. 3 to describe the configuration of a magnetic head manufactured through a manufacturing method of a first embodiment of the invention. Here is given an example of a magnetic head for the perpendicular magnetic recording system wherein a TMR element is employed as the MR element. FIG. 2 is a cross-sectional view for illustrating the configuration of the magnetic head. FIG. 3 is a front view of the medium facing surface of the magnetic head. FIG. 2 illustrates a cross section orthogonal to the medium facing surface and the top surface of a substrate. The arrow indicated with T in FIG. 2 shows the direction of travel of a recording medium.

As shown in FIG. 2, the magnetic head of the embodiment has a medium facing surface 20 that faces toward a recording medium. As shown in FIG. 2 and FIG. 3, the magnetic head incorporates: a substrate 1 made of a ceramic such as aluminum oxide and titanium carbide (Al₂O₃—TiC); an insulating layer 2 made of an insulating material such as alumina (Al₂O₃) and disposed on the substrate 1; a first read shield layer 3 made of a magnetic material and disposed on the insulating layer 2; an MR element 5 disposed on the first read shield layer 3; two bias field applying layers 6 disposed adjacent to the two sides of the MR element 5; an insulating layer 4 disposed between the bias field applying layers 6 and each of the first read shield layer 3 and the MR element 5; and an insulating layer 7 disposed around the MR element 5 and the bias field applying layers 6. The MR element 5 has an end located in the medium facing surface 20. The insulating layer 7 is made of an insulating material such as alumina. The magnetic head further incorporates: a second read shield layer 8 made of a magnetic material and disposed on the MR element 5, the bias field applying layers 6 and the insulating layer 7; and a separating layer 9 made of a nonmagnetic material such as alumina and disposed on the second read shield layer 8. The portion from the first read shield layer 3 to the second read shield layer 8 makes up a read head.

The MR element 5 is a TMR element. A sense current for detecting magnetic signals is fed to the MR element 5 in a direction intersecting the plane of each layer making up the MR element 5, such as the direction perpendicular to the plane of each layer making up the MR element 5.

The magnetic head further incorporates: a yoke layer 10 made of a magnetic material and disposed on the separating layer 9; and an insulating layer 11 made of an insulating material such as alumina and disposed around the yoke layer 10 on the separating layer 9. An end of the yoke layer 10 located closer to the medium facing surface 20 is located at a distance from the medium facing surface 20. The yoke layer 10 and the insulating layer 11 have flattened top surfaces.

The magnetic head further incorporates: a pole layer 12 made of a magnetic material and disposed on the yoke layer 10 and the insulating layer 11; and an insulating layer 13 made of an insulating material such as alumina and disposed around the pole layer 12 on the yoke layer 10 and the insulating layer 11. The pole layer 12 and the insulating layer 13 have flattened top surfaces. The pole layer 12 has an end face located in the medium facing surface 20. The pole layer 12 is connected to the yoke layer 10. The pole layer 12 may be formed of a single layer or may be formed of a plurality of layers stacked. In the embodiment the pole layer 12 is formed of a first layer 121 disposed on the yoke layer 10 and the insulating layer 11, and a second layer 122 disposed on the first layer 121 by way of example.

FIG. 2 illustrates an example in which the yoke layer 10 is located below the pole layer 12, that is, located backward of the pole layer 12 in the direction T of travel of the recording medium (located closer to the air-inflow end of the slider). However, the yoke layer 10 may be located above the pole layer 12, that is, located forward of the pole layer 12 in the direction T of travel of the recording medium (located closer to the air-outflow end of the slider).

The magnetic head further incorporates: a gap layer 14 made of an insulating material such as alumina and disposed on the pole layer 12 and the insulating layer 13; a coil 16 formed on the gap layer 14; and an insulating layer 17 disposed to cover the coil 16. The coil 16 is flat-whorl-shaped. The gap layer 14 has an opening 14a formed in a region corresponding to the center of the coil 16. The insulating layer 17 is made of photoresist, for example. An end of the insulating layer 17 located closer to the medium facing surface 20 is located at a distance from the medium facing surface 20.

The magnetic head further incorporates a write shield layer 15 made of a magnetic material. The write shield layer 15 has: a first layer 151 disposed on the gap layer 14 in a region between the medium facing surface 20 and an end of the insulating layer 17 closer to the medium facing surface 20; and a second layer 152 disposed on the first layer 151 and the insulating layer 17. The second layer 152 is connected to the pole layer 12 through the opening 14a. Each of the first layer 151 and the second layer 152 has an end face located in the medium facing surface 20.

The magnetic head further incorporates an overcoat layer 18 made of an insulating material such as alumina and disposed to cover the write shield layer 15. The portion from the yoke layer 10 to the write shield layer 15 makes up a write head.

In the embodiment the separating layer 9 is formed of an insulating film 9a disposed on the second read shield layer 8 and an insulating film 9b disposed on the insulating film 9a. The magnetic head further incorporates a heater 19 disposed between the insulating films 9a and 9b. Two leads not shown are connected to the heater 19. The heater 19 is provided for heating the components of the write head including the pole layer 12 to control the distance between the recording medium and the end face of the pole layer 12 located in the medium facing surface 20. The heater 19 is energized through the two leads and is thereby made to produce heat, and heats the components of the write head. As a result, the components of the write head expand and the end face of the pole layer 12 located in the medium facing surface 20 thereby gets closer to the recording medium.

As described so far, the magnetic head has the medium facing surface 20 that faces toward the recording medium, the read head, and the write head. The read head and the write head are stacked on the substrate 1. The read head is disposed backward in the direction T of travel of the recording medium (that is, located closer to the air-inflow end of the slider). The write head is disposed forward in the direction T of travel of the recording medium (that is, located closer to the air-outflow end of the slider). The magnetic head writes data on the recording medium through the use of the write head, and reads data stored on the recording medium through the use of the read head.

The read head incorporates the MR element 5, and the first read shield layer 3 and the second read shield layer 8 that are disposed to sandwich the MR element 5 therebetween. FIG. 2 and FIG. 3 illustrate an example in which the MR element 5 is a TMR element. The first read shield layer 3 and the second read shield layer 8 also function as a pair of electrodes for feeding a sense current to the MR element 5 in a direction intersecting the plane of each layer making up the MR element 5, such as the direction perpendicular to the plane of each layer making up the MR element 5. In addition to the first read shield layer 3 and the second read shield layer 8, a pair of electrodes may be respectively provided on top and bottom of the MR element 5. The MR element 5 has a resistance that changes in response to an external magnetic field, that is, a signal magnetic field sent from the recording medium. It is possible to determine the resistance of the MR element 5 from the sense current. In the manner thus described, it is possible to read data stored on the recording medium through the use of the read head.

The MR element 5 is not limited to the TMR element but may be an MR element of any other type, such a GMR element having the CIP structure or a GMR element having the CPP structure. In the case in which the MR element 5 is a GMR element having the CIP structure, a pair of electrodes for feeding a sense current to the MR element 5 are respectively provided on both sides of the MR element 5 taken in the width direction, and shield gap films made of an insulating material are respectively provided between the MR element 5 and the first read shield layer 3 and between the MR element 5 and the second read shield layer 8.

In place of the second read shield layer 8, there may be provided a layered film made up of two magnetic layers and a nonmagnetic layer disposed between the two magnetic layers. The nonmagnetic layer is made of a nonmagnetic material such as ruthenium (Ru) or alumina.

The write head incorporates the yoke layer 10, the pole layer 12, the coil 16 and the write shield layer 15. The coil 16 generates a magnetic field that corresponds to data to be written on the recording medium. The pole layer 12 has an end face located in the medium facing surface 20, and allows a magnetic flux corresponding to the magnetic field generated by the coil 16 to pass and generates a write magnetic field used for writing the data on the recording medium by means of the perpendicular magnetic recording system. The write shield layer 15 has an end face located in the medium facing surface 20 and has a portion located away from the medium facing surface 20 and coupled to the pole layer 12. The pole layer 12 and the write shield layer 15 form a magnetic path through which the magnetic flux corresponding to the magnetic field generated by the coil 16 passes. In the medium facing surface 20 the end face of the write shield layer 15 is located forward of the end face of the pole layer 12 in the direction T of travel of the recording medium (that is, located closer to the air-outflow end of the slider) with a specific small space created by the gap layer 14. The position of the end of a bit pattern to be written on the recording medium is determined by the position of an end of the pole layer 12 that is closer to the gap layer 14 and located in the medium facing surface 20. The shield layer 15 takes in a magnetic flux that is generated from the end face of the pole layer 12 closer to the medium facing surface 20 and that extends in directions except the direction orthogonal to the surface of the recording medium, and thereby prevents this flux from reaching the recording medium. It is thereby possible to prevent the direction of magnetization in the bit pattern already written on the recording medium from changing due to the influence of the above-mentioned flux. It is thereby possible to improve linear recording density. Furthermore, the write shield layer 15 takes in a disturbance magnetic field applied from outside the magnetic head to the magnetic head. It is thereby possible to prevent erroneous writing on the recording medium caused by the disturbance magnetic field intensively taken in into the pole layer 12. The write shield layer 15 also has a function of returning a magnetic flux that has been generated from the end face of the pole layer 12 and has magnetized the recording medium.

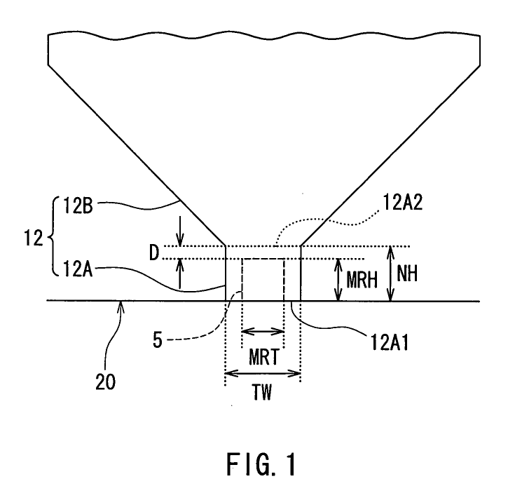

Reference is now made to FIG. 1 to describe details of the shape of the pole layer 12 and the positional relationship between the MR element 5 and the pole layer 12. FIG. 1 is a top view of a portion of the pole layer 12 near the medium facing surface 20. The pole layer 12 includes a track width defining portion 12A and a wide portion 12B. The track width defining portion 12A includes a first end 12A1 located in the medium facing surface 20 and a second end 12A2 located away from the medium facing surface 20, and has a width that defines track width TW. The wide portion 12B is coupled to the second end 12A2 of the track width defining portion 12A and has a width greater than the width of the track width defining portion 12A. The width of the track width defining portion 12A is nearly uniform. The wide portion 12B is, for example, equal in width to the track width defining portion 12A at the boundary with the track width defining portion 12A, and gradually increases in width as the distance from the medium facing surface 20 increases and then maintains a specific width to the end of the wide portion 12B. Here, the distance from the medium facing surface 20 to the boundary between the track width defining portion 12A and the wide portion 12B, that is, the length of the track width defining portion 12A taken in the direction orthogonal to the medium facing surface 20 is called a neck height and indicated with NH.

The MR element 5 is located below the track width defining portion 12A, that is, located closer to the substrate 1 than the track width defining portion 12A. The length of the MR element 5 taken in the direction orthogonal to the medium facing surface 20 is called an MR height and indicated with MRH. The difference between neck height NH and MR height MRH ‘NH−MRH’ is indicated with D. FIG. 1 illustrates an example in which the neck height NH is greater than the MR height MRH. In this case, the difference D is of a positive value. In the case in which the neck height NH is smaller than the MR height MRH, the difference D is of a negative value. The width (the length in the direction of track width) of the MR element 5 is indicated with MRT.

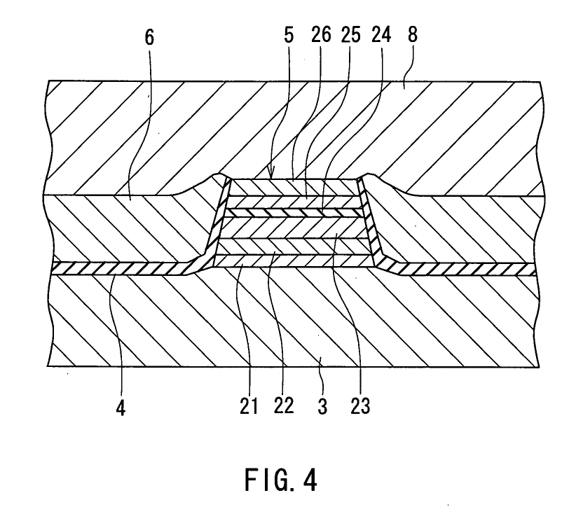

Reference is now made to FIG. 4 to describe an example of configuration of the MR element 5. FIG. 4 is a cross-sectional view for illustrating a cross section of the MR element 5 parallel to the medium facing surface 20. The MR element 5 of FIG. 4 incorporates: a pinned layer 23 that is a ferromagnetic layer having a fixed direction of magnetization; a free layer 25 that is a ferromagnetic layer having a direction of magnetization that changes in response to an external magnetic field; and a spacer layer 24 disposed between the pinned layer 23 and the free layer 25. In the example shown in FIG. 4, the pinned layer 23 is located closer to the first read shield layer 3 than the free layer 25. The MR element 5 of FIG. 4 further incorporates: an antiferromagnetic layer 22 disposed on a side of the pinned layer 23 farther from the spacer layer 24; an underlying layer 21 disposed between the first read shield layer 3 and the antiferromagnetic layer 22; and a protection layer 26 disposed between the free layer 25 and the second read shield layer 8. In the MR element 5 of FIG. 4, on the first read shield layer 3, there are stacked the underlying layer 21, the antiferromagnetic layer 22, the pinned layer 23, the spacer layer 24, the free layer 25 and the protection layer 26 in this order. The insulating layer 4 is provided between the bias field applying layers 6 and each of the first read shield layer 3 and the MR element 5.

The antiferromagnetic layer 22 is a layer that fixes the direction of magnetization of the pinned layer 23 by exchange coupling with the pinned layer 23. The underlying layer 21 is provided for improving the crystallinity and orientability of each layer formed thereon and particularly for enhancing the exchange coupling between the antiferromagnetic layer 22 and the pinned layer 23. The protection layer 26 is a layer for protecting the layers therebelow. In the pinned layer 23 the direction of magnetization is fixed by exchange coupling with the antiferromagnetic layer 22 at the interface with the antiferromagnetic layer 22.

In the case in which the MR element 5 is a TMR element, the spacer layer 24 is a tunnel barrier layer that allows electrons to pass therethrough while the electrons maintain spins by means of the tunnel effect. In the case in which the MR element 5 is a GMR element having the CPP structure, the spacer layer 24 is a nonmagnetic conductive layer.

In the example shown in FIG. 4, the two side surfaces of the MR element 5 are not orthogonal to the top surface of the substrate 1, and the width of the MR element 5 decreases toward the top thereof. In the embodiment, in such a case, the width MRT of the MR element 5 is defined as follows. In the case in which the MR element 5 is a TMR element, the width of the spacer layer 24 that is a tunnel barrier layer is defined as the width MRT of the MR element 5. In the case in which the MR element 5 is a GMR element having the CPP structure or a GMR element having the CIP structure, the distance between the two side surfaces of the free layer 25 taken in the direction of track width is defined as the width MRT of the MR element 5 by way of example.

A method of manufacturing the magnetic head of the embodiment will now be described. The method of the embodiment includes the step of fabricating a magnetic head substructure in which a plurality of pre-head portions each of which will be the magnetic head later are aligned in a plurality of rows by forming components of a plurality of magnetic heads on a single substrate, and the step of fabricating the plurality of magnetic heads by separating the plurality of pre-head portions by cutting the magnetic head substructure.

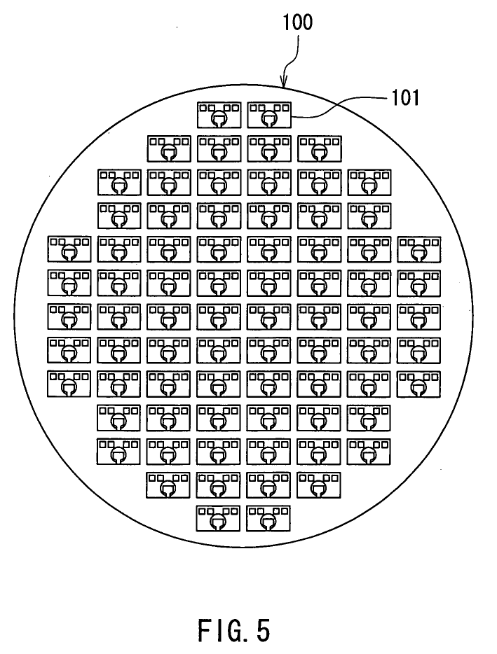

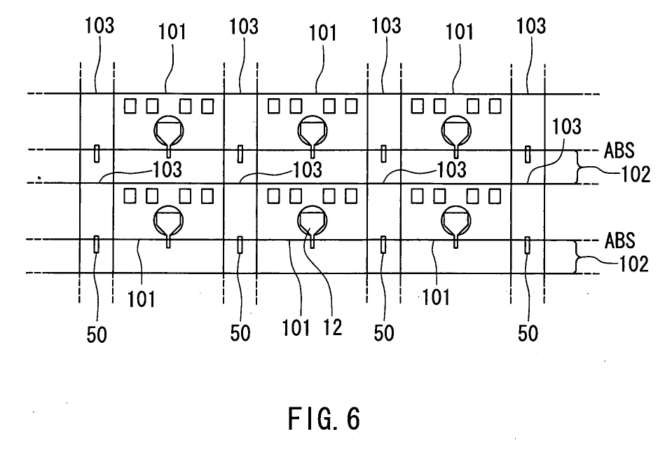

FIG. 5 is a top view of the magnetic head substructure. FIG. 6 is a view for illustrating part of the magnetic head substructure. As shown in FIG. 5 and FIG. 6, the magnetic head substructure (hereinafter simply called the substructure) 100 incorporates pre-head portions 101 aligned in a plurality of rows. In FIG. 6 ‘ABS’ indicates an imaginary plane located at the target position of the medium facing surface 20. In the embodiment a group of pre-head portions 101 aligned in the direction parallel to the plane ABS, that is, the horizontal direction in FIG. 6, is called a row.

The substructure 100 further incorporates: inter-row portions to be removed 102 each of which is located between adjacent two rows; and intra-row portions to be removed 103 each of which is located between two of the pre-head portions 101 adjacent to each other in each row. Neither of the portions 102 and 103 will remain in the magnetic heads.

The substructure 100 further incorporates a plurality of resistor lapping guides (hereinafter referred to as RLG) 50 each of which is disposed to extend across a different one of the intra-row portions to be removed 103 and part of one of the inter-row portions to be removed 102 adjacent thereto. Each RLG 50 is a resistor film having a specific shape. Each RLG 50 is located at such a position that the distance between the RLG 50 and the top surface of the substrate 1 is equal to the distance between the MR element 5 and the top surface of the substrate 1. Two leads not shown are connected to each RLG 50 and it is thereby possible to energize the RLG 50 through the two leads. The function of the RLG 50 will be described in detail layer.

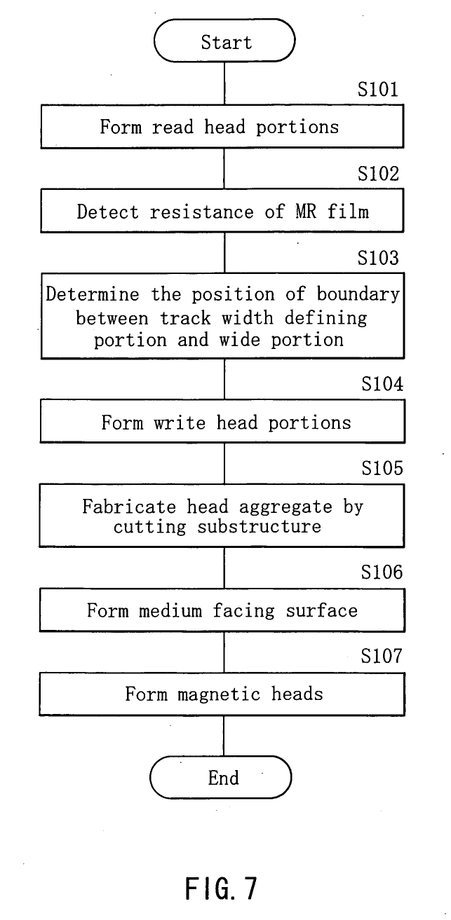

Reference is now made to FIG. 7 to describe the outline of the method of manufacturing the magnetic head of the embodiment. In FIG. 7, Steps S101 to S104 are included in the step of fabricating the substructure 100, and Steps S105 to S107 are included in the step of fabricating the magnetic heads.

In the step of fabricating the substructure 100, first, a plurality of read head portions each of which will be the read head later are formed on a single substrate (Step S101). Each of the read head portions includes a magnetoresistive film (hereinafter referred to as an MR film) that will be formed into the MR element 5 by undergoing lapping later. Therefore, the step of forming the read head portions (Step S101) includes the step of forming the MR films. In the step of forming the read head portions, the RLGs 50 are also formed.

Next, the resistance of the MR films are detected (Step S102). Next, based on the resistance of the MR films detected in step S102, the target position of the boundary between the track width defining portion 12A and the wide portion 12B of the pole layer 12 is detected (Step S103).

Next, a plurality of write head portions each of which will be the write head later are formed (Step S104). Each of the write head portions includes the pole layer 12. Therefore, the step of forming the write head portions (Step S104) includes the step of forming the pole layers 12. In the step of forming the pole layers 12, each of the pole layers 12 is formed such that the actual position of the boundary between the track width defining portion 12A and the wide portion 12B coincides with the target position determined in Step S103.

The substructure 100 is thus fabricated through the foregoing steps. Next, in the step of fabricating the magnetic heads, first, the substructure 100 is cut at a position in the inter-row portion to be removed 102 shown in FIG. 6 to fabricate a head aggregate including a plurality of pre-head portions 101 aligned in a row (Step S105).

Next, the medium facing surface 20 is formed in each of the pre-head portions 101 that the head aggregate includes by lapping the surface (the surface closer to the plane ABS) formed in the head aggregate by cutting the substructure 100 (Step S106). In this step of forming the medium facing surface 20 (Step S106), lapping is performed such that the MR film is lapped so that the resistance thereof reaches a predetermined value and the MR film is thereby formed into the MR element 5.

Next, the head aggregate is cut so that the plurality of pre-head portions 101 are separated from one another, and a plurality of magnetic heads are thereby formed (Step S107).

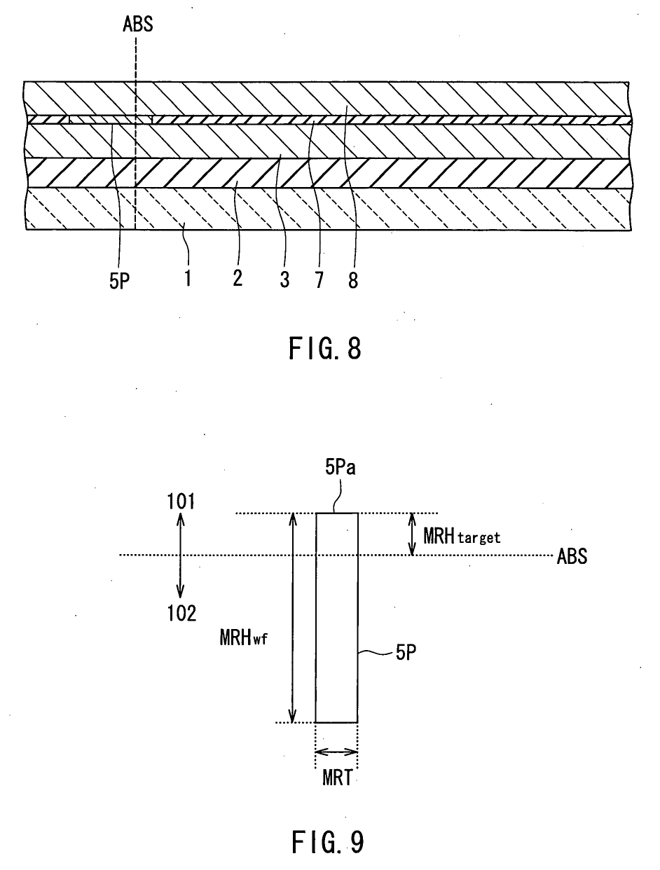

Reference is now made to FIG. 8 to FIG. 13 to describe the step of fabricating substructure 100 (Steps S101 to S104) in detail. Reference is first made to FIG. 8 to describe Step S101 of FIG. 7. FIG. 8 illustrates a cross section of a layered structure obtained in the course of a process of fabricating the substructure 100, the cross section being orthogonal to the medium facing surface and the top surface of the substrate. In Step S101, first, the insulating layer 2 is formed on the substrate 1. Next, the first read shield layer 3 is formed on the insulating layer 2. Next, the MR film 5P, the two bias field applying layers 6 and the insulating layer 7 are formed on the first read shield layer 3. Next, the second read shield layer 8 is formed on the MR film 5P, the bias field applying layers 6 and the insulating layer 7. The MR film 5P has a film configuration the same as that of the MR element 5 to be formed, and the configuration may be one shown in FIG. 4, for example.

FIG. 9 is a top view of the MR film 5P. The top surface of the MR film 5P is rectangular in shape. The MR film 5P is disposed to extend across the pre-head portion 101 and part of the intra-row portion to be removed 102 that are adjacent to each other with the plane ABS located in between. Here, the length of the MR film 5P as initially formed taken in the direction orthogonal to the medium facing surface 20 (the vertical direction in FIG. 9) is indicated with MRH_{wf}. The width of the MR film 5P is equal to the width MRT of the MR element 5 to be formed. Of the two ends of the MR film 5P opposed to each other in the direction orthogonal to the medium facing surface 20, the end 5Pa located in the pre-head portion 101 will be an end of the MR element 5 farther from the medium facing surface 20 later.

In the embodiment, after the second read shield layer 8 is formed, the resistance of the MR film 5P is detected (Step S102) at some stage before the pole layer 12 is formed. The resistance of the MR film 5P is indicated with MRR_{wf}. It is possible to detect the resistance MRR_{wf} of the MR film 5P by feeding a current to the MR film 5P through the use of the first read shield layer 3 and the second read shield layer 8. Here, the resistance of one of the MR films 5P may be detected and the value thus obtained may be defined as the resistance MRR_{wf}. Alternatively, the resistances of a plurality of MR films 5P may be detected and the mean value thereof may be defined as the resistance MRR_{wf}.

In the embodiment, based on the resistance MRR_{wf}, the target value MRH_{target} of the MR height is determined in the following manner so that the resistances of the MR elements 5 are uniform. Here, the target value of the resistance of the MR element 5 is indicated with MRR_{target}. The target value MRH_{target} of the MR height is obtained from Equation (1) below.

MRH_{target}=MRH_{wf}×MRR_{wf}/MRR_{target} (1)

Even in the case in which variations occur in the resistance MRR_{wf} because of variations in resistance-area product and the width MRT of the MR films 5P, if the MR elements 5 are formed such that the actual MR height MRH is equal to the target value MRH_{target}, it is possible to make the resistances of the MR elements 5 be of a uniform value equal to the target value MRR_{target}. As thus described, in the embodiment, although the MR height MRH changes with the resistance MRR_{wf}, it is possible to make the resistances of the MR elements 5 be of a uniform value.

Once the target value MRH_{target} of the MR height is determined as described above, the target position of the medium facing surface 20 (the position of the plane ABS) is also determined. Furthermore, in the embodiment, the target position of the boundary between the track width defining portion 12A and the wide portion 12B of the pole layer 12 to be formed later is determined (Step S103) based on the resistance MRR_{wf}. This target position of the boundary between the track width defining portion 12A and the wide portion 12B is determined in the following manner so that the neck height NH is uniform. Here, the target value of the neck height NH is indicated with NH_{target}. In the embodiment, the difference D between the neck height NH and the MR height MRH shown in FIG. 1 is obtained from Equation (2) below.

$$\begin{matrix}D = {NH}_{target} - {MRH}_{target} \\ = {NH}_{target} - {MRH}_{wf} \times {MRR}_{wf} / {MRR}_{target}\end{matrix} \qquad ( 2 )$$

The target position of the boundary between the track width defining portion 12A and the wide portion 12B is the position away from the end 5Pa of the MR film 5P by the difference D along the direction orthogonal to the plane ABS. If the difference D is of a positive value, the target position of the boundary between the track width defining portion 12A and the wide portion 12B is the position farther from the plane ABS than the end 5Pa of the MR film 5P. If the difference D is of a negative value, the target position of the boundary between the track width defining portion 12A and the wide portion 12B is the position closer to the plane ABS than the end 5Pa of the MR film 5P. It can also be said that the target position of the boundary between the track width defining portion 12A and the wide portion 12B is the position away from the target position of the medium facing surface 20 (the position of the plane ABS) determined as previously described, by a distance equal to the target value NH_{target} of the neck height NH.

In Step S102, it is preferred that the resistance of the MR film 5P be detected while a magnetic field is applied to the MR film 5P. In particular, in the case in which the MR film 5P includes the pinned layer 23, the free layer 25 and the spacer layer 24 as shown in FIG. 4, for example, in Step S102 it is preferred that the resistance of the MR film 5P be detected with the direction of magnetization of the free layer 25 rendered parallel to the direction of magnetization of the pinned layer 23 by applying a magnetic field to the MR film 5P. By detecting the resistance of the MR film 5P as thus described, the accuracy in detection of the resistance of the MR film 5P is enhanced, and the accuracy in the target position of the boundary between the track width defining portion 12A and the wide portion 12B is thereby enhanced, too.

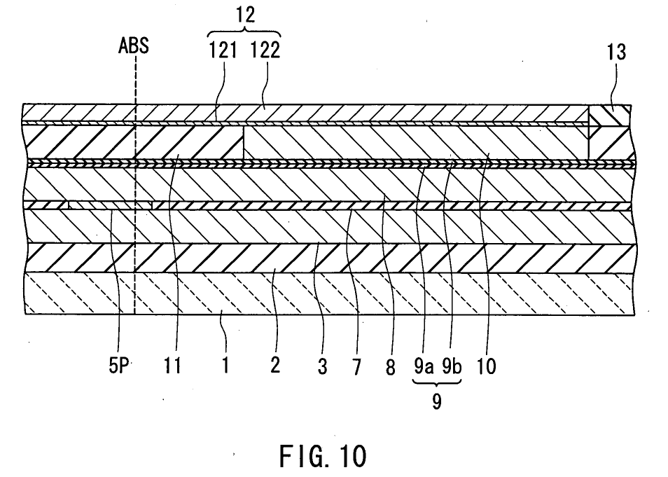

In the following step of the embodiment, a plurality of write head portions each of which will be the write head later are formed (Step S104). This step will now be described with reference to FIG. 10 to FIG. 13. FIG. 10 illustrates a cross section of the layered structure obtained in the course of the process of fabricating the substructure 100, the cross section being orthogonal to the medium facing surface and the top surface of the substrate. In Step S104, first, the insulating film 9a is formed on the second read shield layer 8. Next, the heater 19 of FIG. 2 and two leads not shown are formed on the insulating film 9. Next, the insulating film 9b is formed on the insulating film 9a and the heater 19. Next, the yoke layer 10 and the insulating layer 11 are formed on the separating layer 9 made up of the insulating films 9a and 9b. Next, the pole layer 12 and the insulating layer 13 are formed on the yoke layer 10 and the insulating layer 11.

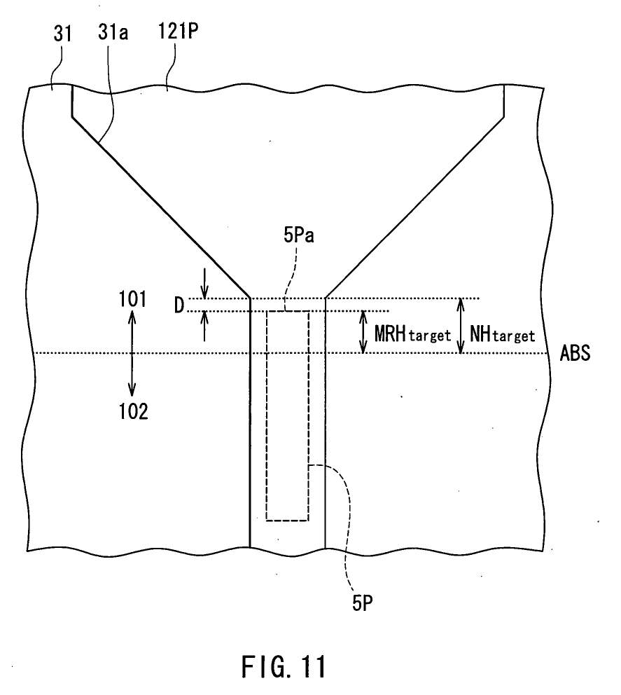

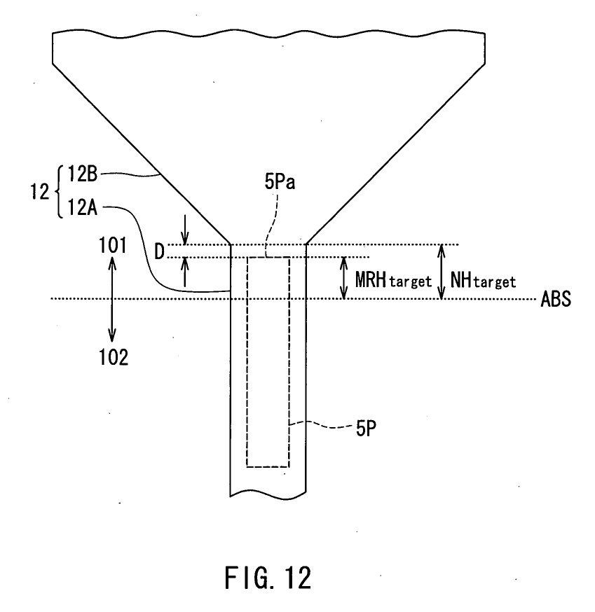

The pole layer 12 may be formed by frame plating or may be formed by making an unpatterned magnetic layer and then patterning the magnetic layer by etching. Here, a method of forming the pole layer 12 by frame plating will be described by way of example, referring to FIG. 11 and FIG. 12. Each of FIG. 11 and FIG. 12 is a top view of a layered structure obtained in the course of the process of fabricating the substructure 100. In this method, as shown in FIG. 11, an electrode film 121P for plating made of a magnetic material is first formed on the yoke layer 10 and the insulating layer 11. Next, a photoresist layer is formed on the electrode film 121P. Next, the photoresist layer is patterned to form a frame 31. The frame 31 has an opening 31a having a shape corresponding the shape of the pole layer 12 to be formed. Next, the second layer 122 is formed by frame plating on the electrode film 121P in the opening 31a of the frame 31. The frame 31 is then removed. Next, the electrode film 121P except a portion thereof located below the second layer 122 is removed by etching. The remaining portion of the electrode film 121P becomes the first layer 121. The pole layer 12 having the track width defining portion 12A and the wide portion 12B is thus formed, as shown in FIG. 12. At this point, the track width defining portion 12A extends over the plane ABS and reaches the inter-row portion to be removed 102.

In the embodiment, in the step of forming the pole layer 12, the pole layer 12 is formed such that the actual position of the boundary between the track width defining portion 12A and the wide portion 12B coincides with the target position determined in Step S103. To be specific, as shown in FIG. 12, the target position of the boundary between the track width defining portion 12A and the wide portion 12B is determined to be the position away from the end 5Pa of the MR film 5P by the difference D obtained from Equation (2) in Step S103 along the direction orthogonal to the plane ABS. The target position of the boundary between the track width defining portion 12A and the wide portion 12B is also the position away from the target position of the medium facing surface 20 (the position of the plane ABS), determined in Step S103, by a distance equal to the target value NH_{target} of the neck height NH.

While FIG. 7 illustrates that Steps S102 and S103 are performed before Step S104 for the sake of convenience, Steps S102 and S103 can be performed at any stage after Step S101 and before the step of forming the frame 31 in Step S104.

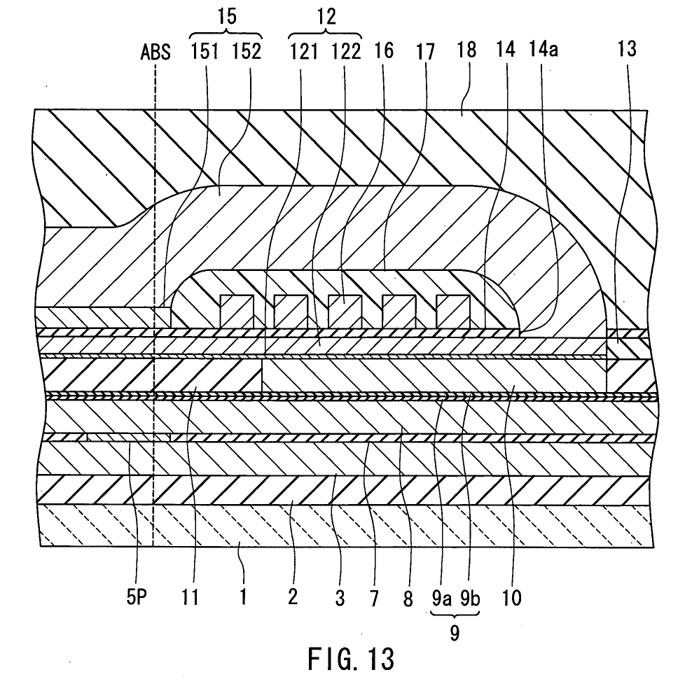

FIG. 13 illustrates the step that follows the step of FIG. 10. FIG. 13 shows a cross section of the substructure 100 orthogonal to the medium facing surface and the top surface of the substrate. In the step, first, the gap layer 14 is formed on the pole layer 12. Next, the first layer 151 of the write shield layer 15 and the coil 16 are formed on the gap layer 14. Next, the insulating layer 17 is formed to cover the coil 16. Next, the second layer 152 of the write shield layer 15 is formed. At this point, each of the first layer 151 and the second layer 152 extends over the plane ABS and reaches the inter-row portion to be removed 102. Next, the overcoat layer 18 is formed.

Next, wiring and terminals and so on are formed on the overcoat layer 18. In each of the pre-head portions 101, two terminals connected to the MR element 5 and two terminals connected to the coil 16 are formed on the overcoat layer 18. As thus described, the components of a plurality of magnetic heads are formed on the single substrate 1 to thereby fabricate the substructure 100 in which the pre-head portions 101 each of which will be the magnetic head later are aligned in a plurality of rows, as shown in FIG. 5 and FIG. 6.

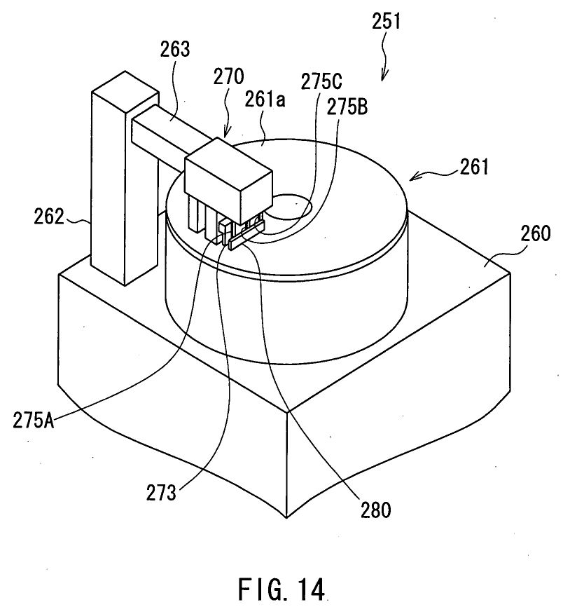

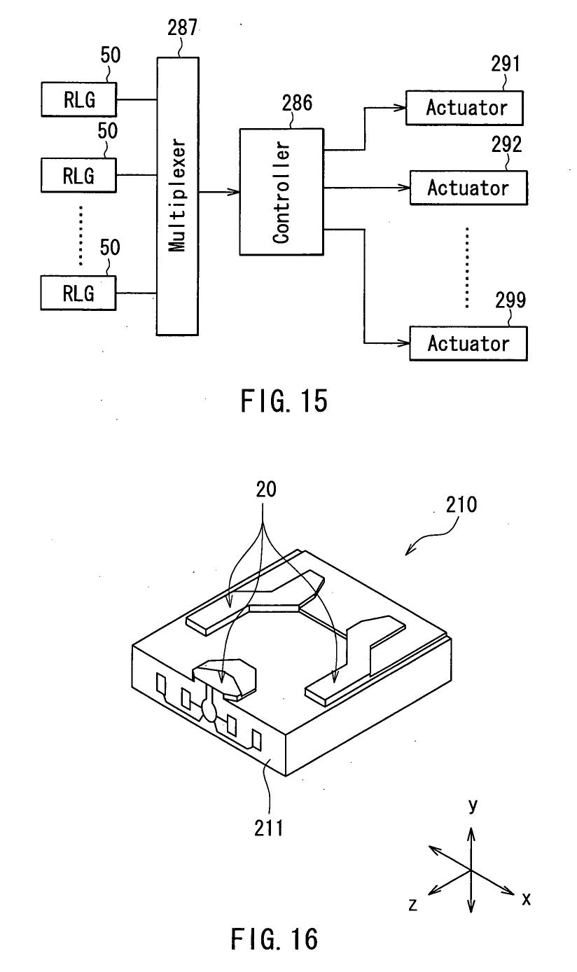

Reference is now made to FIG. 14 and FIG. 15 to describe the step of fabricating the magnetic heads (Steps S105 to S107) in detail. In the step, first, the substructure 100 is cut at the position of the inter-row portion to be removed 102 shown in FIG. 6 to thereby fabricate a head aggregate including a plurality of pre-head portions 101 aligned in a row (Step S105).

Next, the surface (the surface closer to the plane ABS) formed in the head aggregate by cutting the substructure 100 is lapped to form the medium facing surface 20 of each of the pre-head portions 101 that the head aggregate includes (Step S106). In this step of forming the medium facing surface 20 (Step S106), lapping is performed such that the MR film 5P is lapped and the resistance thereof thereby reaches a predetermined value, that is, the target value MRR_{target}, and as a result, the MR film 5P is thereby formed into the MR element 5. In the step of forming the medium facing surface 20, the track width defining portion 12A, the first layer 151 and the second layer 152 are also lapped.

When lapping is performed to form the medium facing surface 20, both the MR film 5P and the RLG 50 are lapped and the resistances thereof are thereby changed. The shape and location of the RLG 50 are predetermined such that the resistance thereof constantly has a specific relationship with the resistance of the MR film 5P when lapping is performed to form the medium facing surface 20. As a result, it is possible to perform lapping so that the resistance of the MR film 5P becomes equal to the target value MRR_{target} by monitoring the resistance of the RLG 50 when lapping is performed to form the medium facing surface 20.

FIG. 14 is a perspective view illustrating an example of configuration of a lapping apparatus for lapping the head aggregate. This lapping apparatus 251 incorporates: a table 260; a rotating lapping table 261 provided on the table 260; a strut 262 provided on the table 260 on a side of the rotating lapping table 261; and a supporter 270 attached to the strut 262 through an arm 263. The rotating lapping table 261 has a lapping plate (surface plate) 261a to come to contact with the surface to be the medium facing surfaces 20 of the pre-head portions 101 that the head aggregate includes.

The supporter 270 incorporates a jig retainer 273 and three load application rods 275A, 275B and 275C placed in front of the jig retainer 273 at equal spacings. A jig 280 is to be fixed to the jig retainer 273. The jig 280 has three load application sections each of which is made up of a hole having an oblong cross section. Load application pins are provided at the lower ends of the load application rods 275A, 275B and 275C, respectively. The load application pins have respective heads to be inserted to the load application sections (holes) of the jig 280, the heads each having an oblong cross section. Each of the load application pins is driven by an actuator (not shown) in the vertical, horizontal (along the length of the jig 280) and rotational directions.

The jig 280 has a retainer for retaining the head aggregate. With this jig 280, the retainer and the head aggregate are deformed by applying loads in various directions to the three load application sections. It is thereby possible that the surface to be the medium facing surfaces 20 of the pre-head portions 101 that the head aggregate includes is lapped while the MR heights and neck heights of the plurality of pre-head portions 101 that the head aggregate includes are controlled to coincide with the respective target values.

FIG. 15 is a block diagram showing an example of circuit configuration of the lapping apparatus shown in FIG. 14. This lapping apparatus incorporates: nine actuators 291 to 299 for applying loads in the three directions to the load application sections of the jig 280; a controller 286 for controlling the actuators 291 to 299 through monitoring the resistances of the plurality of RLGs 50 in the head aggregate; and a multiplexer 287, connected to the plurality of RLGs 50 in the head aggregate 212 through a connector (not shown), for selectively connecting one of the RLGs 50 to the controller 286.

In this lapping apparatus, the controller 286 monitors the resistances of the plurality of RLGs 50 in the head aggregate through the multiplexer 287, and controls the actuators 291 to 299 so that the resistance of each of the plurality of RLGs 50 in the head aggregate coincides with the target value MRR_{target} of the resistance of the MR element 5, or falls within a tolerance of the target value MRR_{target}.

In the embodiment, it is possible to make the neck height NH coincide with the target value NH_{target} by forming the medium facing surfaces 20 such that the resistance of each of the MR films 5P coincides with the target value MRR_{target}.

Flying rails are formed by etching, for example, in the medium facing surfaces 20 formed by lapping as described above. The head aggregate is then cut at the positions of the intra-row portions to be removed 103 of FIG. 6 so that the plurality of pre-head portions 101 are separated from one another, and a plurality of magnetic heads are thereby formed (Step S107).

The specific details of the step of fabricating the magnetic heads are not limited to the example described above. For example, the magnetic heads may be fabricated in the following manner. First, the substructure 100 is cut to fabricate a first head aggregate that includes a plurality of pre-head portions 101 aligned in a plurality of rows. Next, a surface of the first head aggregate is lapped to form the medium facing surfaces 20 of a single row of pre-head portions 101. Next, the first head aggregate is cut so that the single row of pre-head portions 101 in which the medium facing surfaces 20 have been formed is separated to be a second head aggregate. Next, the second head aggregate is cut so that the plurality of pre-head portions 101 are separated from one another, and a plurality of magnetic heads are thereby fabricated.

According to the embodiment as thus described, in the step of fabricating the substructure 100, the resistance of the MR film 5P is detected, and the target position of the boundary between the track width defining portion 12A and the wide portion 12B of the pole layer 12 is determined based on the resistance MRR_{wf} of the MR film 5P detected, and the pole layer 12 is formed such that the actual position of the boundary between the track width defining portion 12A and the wide portion 12B coincides with the target position. In the step of fabricating the magnetic heads, the surface formed by cutting the substructure 100 is lapped such that the MR film 5P is lapped and the resistance thereof thereby reaches a predetermined value MRR_{target}, and as a result, the MR film 5P is formed into the MR element 5. According to the embodiment, it is thereby possible to reduce variations in both resistance of the MR element 5 and the neck height NH of the pole layer 12.

A specific example will now be given to further describe the effects of the embodiment. A standard example will be first given. In this example, the resistance-area product RA of the MR film 5P and the MR element 5 is 3 Ω-μm². The width MRT of the MR film 5P and the MR element 5 is 0.08 μm. The length MRH_{wf} of the MR film 5P as initially formed is 0.5 μm. The target value MRH_{target} of the MR height is 0.1 μm. The resistance MRR_{wf} of the MR film 5P as initially formed is 75Ω. The target value MRR_{target} of the resistance of the MR element 5 is 375Ω. These values are shown together on Table 1 below.

TABLE 1

| | MR film 5P | MR element 5 |
|---|---|---|
| RA (Ω-μm²) | 3 | 3 |
| MRT (μm) | 0.08 | 0.08 |
| Length (μm) | (MRH_{wf}) 0.5 | (MRH_{target}) 0.1 |
| Resistance (Ω) | (MRR_{wf}) 75 | (MRR_{target}) 375 |

In this example the target value NH_{target} of the neck height NH is 0.12 μm. If the MR film 5P and the MR element 5 conform to the above-listed standard, the difference D between the neck height NH and the MR height MRH is 0.02 μm.

Consideration will now be given to a case in which the resistance MRR_{wf} of the MR film 5P deviates from the above-listed standard value 75Ω due to variations in resistance-area product and/or width MRT of the MR film 5P. In this case, too, it is possible to make the resistance of the MR element 5 be of a uniform value equal to the target value MRR_{target} if the target value MRH_{target} of the MR height is determined by using Equation (1) and the MR element 5 is formed such that the actual MR height MRH is equal to the target value MRH_{target}. Here, the following first and second examples will be considered, assuming that the resistance MRR_{wf} of the MR film 5P deviates from the above-listed standard value 75Ω. The first example is one in which the resistance MRR_{wf} is 65Ω. The second example is one in which the resistance MRR_{wf} is 85Ω.

In the first example, the target value MRH_{target} of the MR height determined by using Equation (1) is 0.087 μm. In the conventional method of manufacturing a magnetic head, the difference D between the neck height NH and the MR height MRH is determined in advance. As a result, according to the conventional method, in the case of the first example, the actual neck height is of the value obtained by adding 0.02 μm that is the difference D to 0.087 μm that is the target value MRH_{target} of the MR height, that is, the value obtained is 0.107 μm, which is smaller than 0.12 μm that is the target value NH_{target}.

In the second example, the target value MRH_{target} of the MR height determined by using Equation (1) is 0.113 μm. Therefore, according to the conventional method of manufacturing a magnetic head, in the case of the second example, the actual neck height is of the value obtained by adding 0.02 μm that is the difference D to 0.113 μm that is the target value MRH_{target} of the MR height, that is, the value obtained is 0.133 μm, which is greater than 0.12 μm that is the target value NH_{target}.

In the embodiment, in contrast, the difference D is determined by using Equation (2) based on the resistance MRR_{wf} of the MR film 5P. As a result, according to the embodiment, in the first example, the difference D is 0.033 μm, and the actual neck height is of the value obtained by adding 0.033 μm that is the difference D to 0.087 μm that is the target value MRH_{target} of the MR height, that is, the value obtained is 0.12 μm, which is equal to the target value NH_{target}. In the second example, the difference D is 0.007 μm, and the actual neck height is of the value obtained by adding 0.007 μm that is the difference D to 0.113 μm that is the target value MRH_{target} of the MR height, that is, the value obtained is 0.12 μm, which is equal to the target value NH_{target}.

Reference is now made to FIG. 16 to FIG. 19 to describe a head gimbal assembly, a head arm assembly and a magnetic disk drive each of which employs the magnetic head of the embodiment. Reference is first made to FIG. 16 to describe an example of appearance of the magnetic head of the embodiment. The magnetic head of FIG. 16 is in the form of a slider. Therefore, the magnetic head is called a slider 210 in FIG. 16 to FIG. 19. In the magnetic disk drive, the slider 210 is placed to face toward a magnetic disk platter that is a circular-plate-shaped recording medium to be driven to rotate. The slider 210 has a base body 211 made up mainly of the substrate 1 and the overcoat layer 18 of FIG. 2. The base body 211 is nearly hexahedron-shaped. One of the six surfaces of the base body 211 faces toward the magnetic disk platter. The medium facing surface 20 is formed in this one of the surfaces. When the magnetic disk platter rotates in the z direction of FIG. 16, an airflow passes between the magnetic disk platter and the slider 210, and a lift is thereby generated below the slider 210 in the y direction of FIG. 16 and exerted on the slider 210. The slider 210 flies over the magnetic disk platter by means of the lift. The x direction of FIG. 16 is across the tracks of the magnetic disk platter. The read head and the write head are formed near the air-outflow-side end (the end located at the lower left of FIG. 16) of the slider 210.

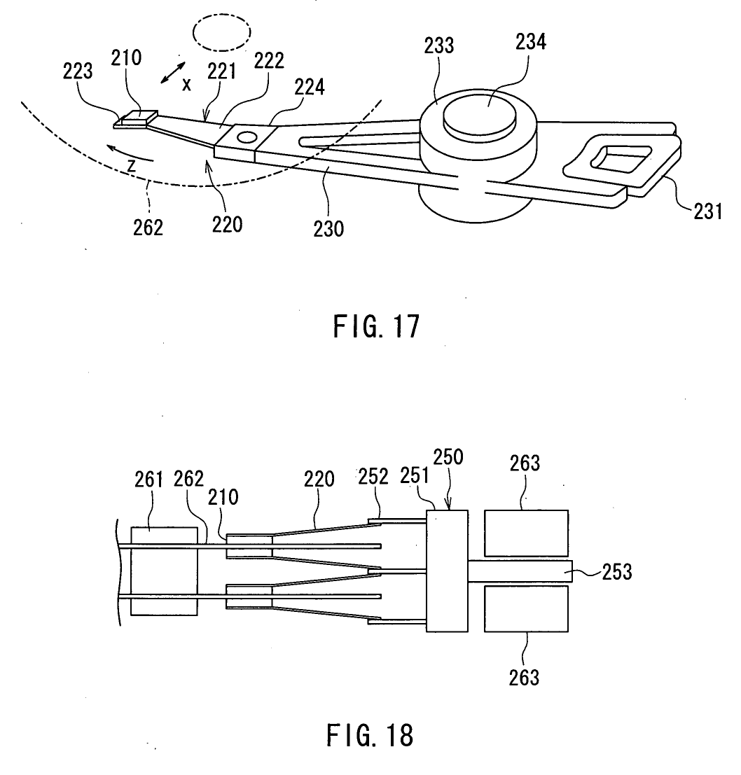

Reference is now made to FIG. 17 to describe the head gimbal assembly 220. The head gimbal assembly 220 incorporates the slider 210 and a suspension 221 that flexibly supports the slider 210. The suspension 221 incorporates: a plate-spring-shaped load beam 222 made of stainless steel, for example; a flexure 223 to which the slider 210 is joined, the flexure 223 being located at an end of the load beam 222 and giving an appropriate degree of freedom to the slider 210; and a base plate 224 located at the other end of the load beam 222. The base plate 224 is attached to an arm 230 of an actuator for moving the slider 210 along the x direction across the tracks of the magnetic disk platter 262. The actuator incorporates the arm 230 and a voice coil motor that drives the arm 230. A gimbal section for maintaining the orientation of the slider 210 is provided in the portion of the flexure 223 on which the slider 210 is mounted.

The head gimbal assembly 220 is attached to the arm 230 of the actuator. An assembly incorporating the arm 230 and the head gimbal assembly 220 attached to the arm 230 is called a head arm assembly. An assembly incorporating a carriage having a plurality of arms wherein the head gimbal assembly 220 is attached to each of the arms is called a head stack assembly.

FIG. 17 illustrates the head arm assembly. In the head arm assembly the head gimbal assembly 220 is attached to an end of the arm 230. A coil 231 that is part of the voice coil motor is fixed to the other end of the arm 230. A bearing 233 is provided in the middle of the arm 230. The bearing 233 is attached to an axis 234 that rotatably supports the arm 230.

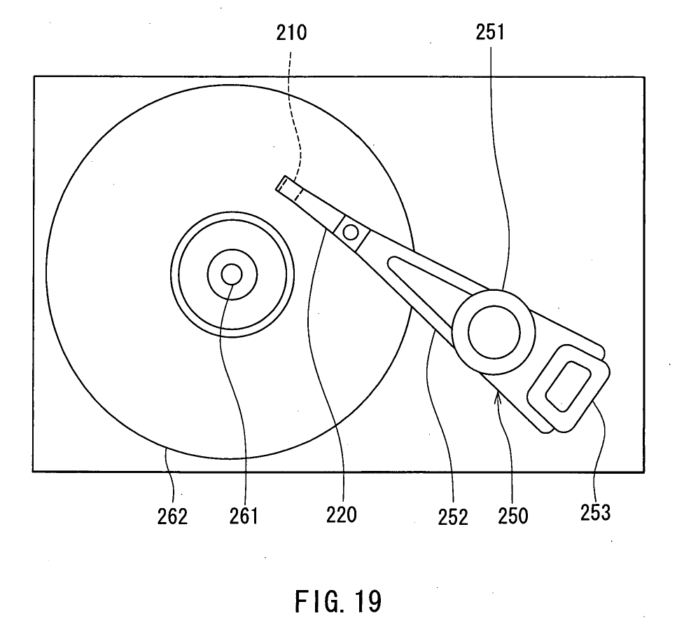

Reference is now made to FIG. 18 and FIG. 19 to describe an example of the head stack assembly and the magnetic disk drive. FIG. 18 illustrates the main part of the magnetic disk drive. FIG. 19 is a top view of the magnetic disk drive. The head stack assembly 250 incorporates a carriage 251 having a plurality of arms 252. A plurality of head gimbal assemblies 220 are attached to the arms.252 such that the assemblies 220 are arranged in the vertical direction with spacing between adjacent ones. A coil 253 that is part of the voice coil motor is mounted on the carriage 251 on a side opposite to the arms 252. The head stack assembly 250 is installed in the magnetic disk drive. The magnetic disk drive includes a plurality of magnetic disk platters 262 mounted on a spindle motor 261. Two of the sliders 210 are allocated to each of the platters 262, such that the two sliders 210 are opposed to each other with each of the platters 262 disposed in between. The voice coil motor includes permanent magnets 263 disposed to be opposed to each other, the coil 253 of the head stack assembly 250 being placed between the magnets 263. The actuator and the head stack assembly 250 except the sliders 210 support the sliders 210 and align them with respect to the magnetic disk platters 262.

In the magnetic disk drive, the actuator moves the slider 210 across the tracks of the magnetic disk platter 262 and aligns the slider 210 with respect to the magnetic disk platter 262. The write head incorporated in the slider 210 writes data on the-magnetic disk platter 262 and the read head incorporated in the slider 210 reads data stored on the magnetic disk platter 262.

### Second Embodiment

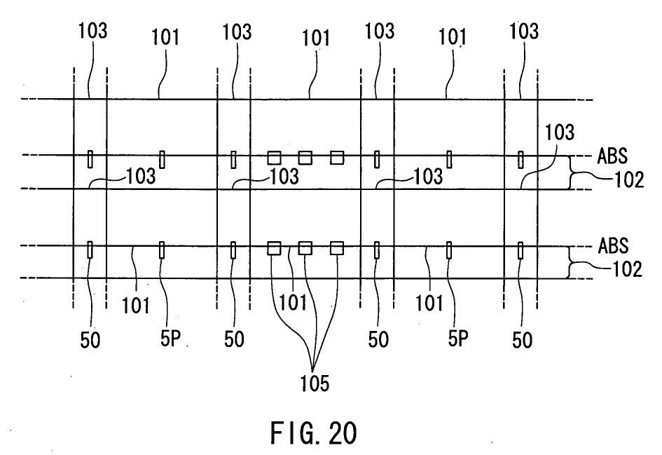

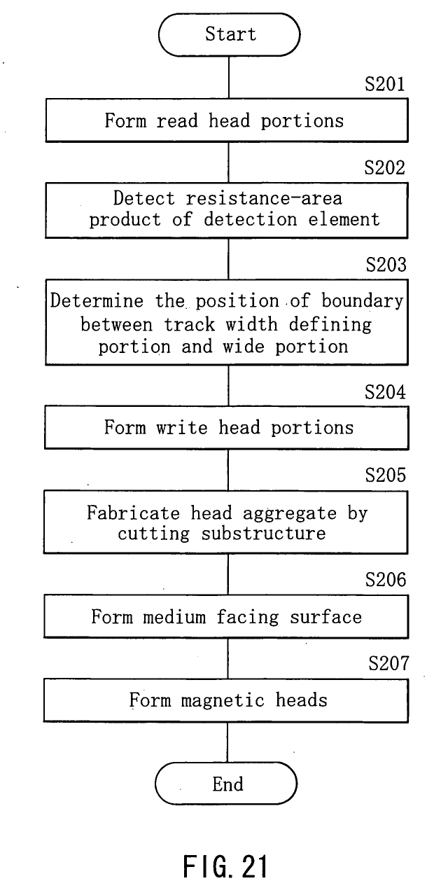

Reference is now made to FIG. 20 and FIG. 21 to describe a method of manufacturing a magnetic head of a second embodiment of the invention. Reference is first made to FIG. 20 to describe the substructure 100 of the second embodiment. FIG. 20 is a view for illustrating part of the substructure 100 of the embodiment. The substructure 100 of the second embodiment incorporates a plurality of detection elements 105 each having a film configuration the same as that of the MR film 5P. Since each of the detection elements 105 has the same film configuration as that of the MR film 5P, each of the detection elements 105 has a resistance-area product the same as that of the MR film 5P. Each of the detection elements 105 may have a shape the same as that of the MR film 5P or different from that of the MR film 5P. The detection elements 105 may be disposed in the pre-head portions 101, or may be disposed to extend across the inside and the outside of the pre-head portions 101. FIG. 20 illustrates an example in which the MR films 5P are not formed in some of the pre-head portions 101, and the detection elements 105 are respectively disposed to extend across each of these pre-head portions 101 without the MR films 5P and part of the adjacent inter-row portion to be removed 102. In this example, the pre-head portions 101 in which the detection elements 105 are disposed will not be used as magnetic heads even after they are separated later. The detection elements 105 are formed at the same time as the MR films 5P are formed.

The substructure 100 of the second embodiment further incorporates first and second electrodes disposed to sandwich the respective detection elements 105. The first and second electrodes are used to feed a current to each of the detection elements 105 when the resistance thereof is detected. The first electrodes are formed at the same time as the first read shield layers 3, for example. The second electrodes are formed at the same time as the second read shield layers 8, for example.

In the embodiment, the value of a parameter having a correspondence with the resistance of the MR film 5P is detected through the use of the detection elements 105, and the target position of the boundary between the track width defining portion 12A and the wide portion 12B of the pole layer 12 is determined based on the value of the parameter detected.

Reference is now made to a flowchart of FIG. 21 to describe the method of manufacturing the magnetic head of the embodiment. In FIG. 21 Steps S201 to S204 are included in the step of fabricating the substructure 100, and Steps S205 to S207 are included in the step of fabricating the magnetic heads.

In the step of fabricating the substructure 100, first, a plurality of read head portions each of which will be the read head later are formed on a single substrate (Step S201). As in the first embodiment, each of the read head portions includes the MR film 5P that will be formed into the MR element 5 by undergoing lapping later. Therefore, the step of forming the read head portions (Step S201) includes the step of forming the MR films 5P. In the second embodiment, the detection elements 105 and the first and second electrodes are formed in the step of forming the read head portions.

Next, the value of the resistance-area product of the detection element 105 is detected as the value of the parameter having a correspondence with the resistance of the MR film 5P (Step S202). If the top surface of the detection element 105 is rectangle-shaped as in the case of the MR film 5P, it is possible to obtain the value of the resistance-area product of the detection element 105 as the product of the resistance of the detection element 105, the length of the detection element 105, and the width of the detection element 105. Since the length and width of the detection element 105 are determined in advance, it is possible to obtain the value of the resistance-area product of the detection element 105 by detecting the resistance thereof. If the two side surfaces of the detection element 105 are not orthogonal to the top surface of the substrate 1 as in the case of the MR element 5 of FIG. 4, the width of the detection element 105 is defined in a manner the same as that of the MR element 5 of FIG. 4, depending on the film configuration of the detection element 105.

Here, the value of the resistance-area product of the detection element 105 detected in Step S202 is indicated with RA_{wf}. In the second embodiment it is possible to obtain the resistance MRR_{wf} of the MR film 5P from Equation (3) below, based on the resistance-area product RA_{wf} of the detection element 105.

MRR_{wf}=RA_{wf}/(MRT×MRHV) (3)

Then, by substituting the resistance MRR_{wf} obtained from Equation (3) into Equation (1), it is possible to obtain the target value MRH_{target} of the MR height. Therefore, according to the second embodiment, it is possible to obtain the target value MRH_{target} of the MR height based on the value of the resistance-area product RA_{wf} of the detection element 105, even without detecting the resistance MRR_{wf} of the MR film 5P.

Next, based on the value of the resistance-area product RA_{wf} of the detection element 105 detected in step S202, the target position of the boundary between the track width defining portion 12A and the wide portion 12B of the pole layer 12 is determined (Step S203). To be specific, the difference D between the neck height NH and the MR height MRH of FIG. 1 is obtained from Equation (4) below.

$$\begin{matrix}D = {NH}_{target} - {MRH}_{target} \\ = {NH}_{target} - {RA}_{wf} / ( MRT \times {MRR}_{target} )\end{matrix} \qquad ( 4 )$$

As in the first embodiment, the target position of the boundary between the track width defining portion 12A and the wide portion 12B is the position away from the end 5Pa of the MR film 5P by the difference D along the direction orthogonal to the plane ABS.

In step S202, it is preferred to detect the resistance and the value of the resistance-area product RA_{wf} of the detection element 105 while a magnetic field is applied to the detection element 105. In particular, in the case in which each of the MR film 5P and the detection element 105 includes the pinned layer 23, the free layer 25 and the spacer layer 24 as shown in FIG. 4, for example, in Step S202 it is preferred to detect the resistance and the value of the resistance-area product RA_{wf} of the detection element 105 with the direction of magnetization of the free layer 25 rendered parallel to the direction of magnetization of the pinned layer 23 by applying a magnetic field to the detection element 105. By detecting the resistance and the value of the resistance-area product RA_{wf} of the detection element 105 as thus described, the accuracy in detection of the value of the resistance-area product RA_{wf} of the detection element 105 is enhanced, and the accuracy in the target position of the boundary between the track width defining portion 12A and the wide portion 12B is thereby enhanced, too.

Next, a plurality of write head portions each of which will be the write head later are formed (Step S204). Each of the write head portions includes the pole layer 12. Therefore, the step of forming the write head portions (Step S204) includes the step of forming the pole layers 12. In the step of forming the pole layers 12, each of the pole layers 12 is formed such that the actual position of the boundary between the track width defining portion 12A and the wide portion 12B coincides with the target position determined in Step S203.

The substructure 100 is thus fabricated through the foregoing steps. The step of fabricating the magnetic heads of the second embodiment is the same as that of the first embodiment. That is, first, the substructure 100 is cut at a position in the inter-row portion to be removed 102 shown in FIG. 6 to fabricate a head aggregate including a plurality of pre-head portions 101 aligned in a row (Step S205). Next, the medium facing surface 20 is formed in each of the pre-head portions 101 that the head aggregate includes by lapping the surface (the surface closer to the plane ABS) formed in the head aggregate by cutting the substructure 100 (Step S206). In this step of forming the medium facing surface 20 (Step S206), lapping is performed such that the MR film 5P is lapped and the resistance thereof thereby reaches a predetermined value, that is, the target value MRR_{target}, and as a result, the MR film 5P is formed into the MR element 5. In the step of forming the medium facing surface 20, the track width defining portion 12A, the first layer 151 and the second layer 152 are also lapped. Next, the head aggregate is cut so that the plurality of pre-head portions 101 are separated from one another, and a plurality of magnetic heads are thereby formed (Step S207).

In the second embodiment, in the case in which the shape of the detection element 105 is the same as that of the MR film 5P, the target position of the boundary between the track width defining portion 12A and the wide portion 12B may be determined in a manner similar to that of the first embodiment by detecting the resistance of the detection element 105 as the value of the parameter having a correspondence with the resistance of the MR film 5P, and using this resistance of the detection element 105 in place of the resistance of the MR film 5P of the first embodiment.

In the second embodiment, in the case in which the shape of the detection element 105 is the same as that of the MR film 5P and the detection element 105 is disposed such that the positional relationship between the plane ABS and the detection element 105 is the same as that between the plane ABS and the MR film 5P, lapping may be controlled such that the resistance of the detection element 105 is equal to the target value MRR_{target} in the step of forming the medium facing surface 20 (Step S206), instead of controlling lapping such that the resistance of the MR film 5P is equal to the target value MRR_{target}.

The remainder of configuration, operation and effects of the second embodiment are similar to those of the first embodiment.

The present invention is not limited to the foregoing embodiments but may be practiced in still other ways. For example, in the first embodiment, the target position of the boundary between the track width defining portion 12A and the wide portion 12B may be determined in a manner similar to that of the second embodiment by obtaining the value of the resistance-area product of the MR film 5P from the resistance of the MR film 5P detected, and using this value of the resistance-area product in place of RA_{wf} of Equation (4).

In each of the first and second embodiments, when lapping is performed to form the medium facing surface 20, lapping may be controlled such that the resistance of the MR film 5P is equal to the target value MRR_{target} by monitoring the resistance of the MR film 5P or by monitoring both the resistance of the RLG 50 and the resistance of the MR film 5P, instead of monitoring the resistance of the RLG 50.

The invention is applicable not only to magnetic heads for the perpendicular magnetic recording system but also to magnetic heads for the longitudinal magnetic recording system.

Obviously many modifications and variations of the present invention are possible in the light of the above teachings. It is therefore to be understood that within the scope of the appended claims the invention may be practiced otherwise than as specifically described.

What is claimed is:

1. A method of manufacturing a magnetic head, the magnetic head comprising:
a medium facing surface that faces toward a recording medium;
a magnetoresistive element having an end located in the medium facing surface and reading data stored on the recording medium;
a coil that generates a magnetic field corresponding to data to be written on the recording medium; and
a pole layer that allows a magnetic flux corresponding to the magnetic field generated by the coil to pass therethrough and generates a write magnetic field for writing the data on the recording medium, wherein
the pole layer includes: a track width defining portion including a first end located in the medium facing surface and a second end located away from the medium facing surface, and having a width that defines a track width; and a wide portion coupled to the second end of the track width defining portion and having a width greater than that of the track width defining portion, the method comprising the steps of:
fabricating a magnetic head substructure in which a plurality of pre-head portions each of which will be the magnetic head later are aligned in a plurality of rows, by forming components of a plurality of magnetic heads on a substrate; and
fabricating the plurality of magnetic heads by separating the pre-head portions from one another through cutting the substructure, wherein:
the step of fabricating the substructure includes the steps of:
forming a magnetoresistive film that will be formed into the magnetoresistive element by undergoing lapping later;
detecting a resistance of the magnetoresistive film;
determining a target position of a boundary between the track width defining portion and the wide portion of the pole layer based on the resistance of the magnetoresistive film detected; and
forming the pole layer such that an actual position of the boundary between the track width defining portion and the wide portion coincides with the target position,
the step of fabricating the magnetic heads includes the step of forming the medium facing surface by lapping a surface formed by cutting the substructure; and,
in the step of forming the medium facing surface, the lapping is performed such that the magnetoresistive film is lapped and the resistance thereof thereby reaches a predetermined value, and as a result, the magnetoresistive film is formed into the magnetoresistive element.

2. The method according to claim 1, wherein, in the step of detecting the resistance of the magnetoresistive film, the resistance of the magnetoresistive film is detected while a magnetic field is applied to the magnetoresistive film.

3. The method according to claim 1, wherein:
the magnetoresistive film includes: a pinned layer having a fixed direction of magnetization; a free layer having a direction of magnetization that changes in response to an external magnetic field; and a spacer layer disposed between the pinned layer and the free layer; and,
in the step of detecting the resistance of the magnetoresistive film, the resistance of the magnetoresistive film is detected with the direction of magnetization of the free layer rendered parallel to the direction of magnetization of the pinned layer by applying a magnetic field to the magnetoresistive film.

4. The method according to claim 1, wherein the magnetic head is one used for a perpendicular magnetic recording system.

5. A method of manufacturing a magnetic head, the magnetic head comprising:
a medium facing surface that faces toward a recording medium;
a magnetoresistive element having an end located in the medium facing surface and reading data stored on the recording medium;
a coil that generates a magnetic field corresponding to data to be written on the recording medium; and
a pole layer that allows a magnetic flux corresponding to the magnetic field generated by the coil to pass therethrough and generates a write magnetic field for writing the data on the recording medium, wherein
the pole layer includes: a track width defining portion including a first end located in the medium facing surface and a second end located away from the medium facing surface, and having a width that defines a track width; and a wide portion coupled to the second end of the track width defining portion and having a width greater than that of the track width defining portion, the method comprising the steps of:
fabricating a magnetic head substructure in which a plurality of pre-head portions each of which will be the magnetic head later are aligned in a plurality of rows, by forming components of a plurality of magnetic heads on a substrate; and
fabricating the plurality of magnetic heads by separating the pre-head portions from one another through cutting the substructure, wherein:
the step of fabricating the substructure includes the steps of:
forming a magnetoresistive film that will be formed into the magnetoresistive element by undergoing lapping later;
detecting a value of a parameter having a correspondence with a resistance of the magnetoresistive film;
determining a target position of a boundary between the track width defining portion and the wide portion of the pole layer based on the value of the parameter detected; and
forming the pole layer such that an actual position of the boundary between the track width defining portion and the wide portion coincides with the target position,
the step of fabricating the magnetic heads includes the step of forming the medium facing surface by lapping a surface formed by cutting the substructure; and,
in the step of forming the medium facing surface, the lapping is performed such that the magnetoresistive film is lapped and the resistance thereof thereby reaches a predetermined value, and as a result, the magnetoresistive film is formed into the magnetoresistive element.

6. The method according to claim 5, wherein:
the step of fabricating the substructure further includes the step of forming a detection element having a resistance-area product equal to that of the magnetoresistive film; and,
in the step of detecting the value of the parameter, a value of the resistance-area product of the detection element is detected as the value of the parameter.

7. The method according to claim 6, wherein, in the step of detecting the value of the resistance-area product of the detection element, the value of the resistance-area product of the detection element is detected while a magnetic field is applied to the detection element.

8. The method according to claim 6, wherein:
each of the magnetoresistive film and the detection element includes: a pinned layer having a fixed direction of magnetization; a free layer having a direction of magnetization that changes in response to an external magnetic field; and a spacer layer disposed between the pinned layer and the free layer; and,
in the step of detecting the value of the resistance-area product of the detection element, the value of the resistance-area product of the detection element is detected with the direction of magnetization of the free layer rendered parallel to the direction of magnetization of the pinned layer by applying a magnetic field to the detection element.

9. The method according to claim 5, wherein the magnetic head is one used for a perpendicular magnetic recording system.
